(19) United States
(12) Patent Application Publication
(10) Pub. No.: US 2008/0249881 A1
(43) Pub. Date: Oct. 9, 2008

(54) METHOD OF ADVERTISING COSMETICS AND PERSONAL CARE PRODUCTS ON BEHALF OF THIRD PARTY BUSINESSES IN ETABLISHMENTS THAT PROVIDE LODGING

(76) Inventor: Martha Suzette Rosenberg, New York, NY (US)

Correspondence Address: MEREDITH & KEYHANI, PLLC, 330 MADISON AVE., 6TH FLOOR, NEW YORK, NY, 10017, US

(21) Appl. No.: 12/141,769

(22) Filed: Jun. 18, 2008

Related U.S. Application Data
(63) Continuation of application No. 10/106,935, filed on Mar. 26, 2002.

(51) Int. Cl. G06Q 30/00

(52) U.S. Cl. 705/14

(57) ABSTRACT

The present invention generally relates to a method of advertising to potential customers. More particularly, the present invention pertains to the display of cosmetic materials within establishments that provide lodging and other services for travelers and other paying guests that is not coincident with the point of sale. These establishments may include hotels, motels, motor inns, bed and breakfasts, country inns, apartments, condominiums, complexes, cottages, lodges, ranches, resorts, suites, extended stays, histories, cruises, other lodging establishments, airplanes, trains, and other modes of transportation and the like.

This application is a continuing application and claims priority to co-pending application Ser. No. 10/106,935 as filed Mar. 26, 2002 and entitled “Method of advertising cosmetics and personal care products on behalf of third part businesses in establishments that provide lodging.”

### BACKGROUND OF THE INVENTION

The present invention generally relates to a method of advertising to potential customers. More particularly, the present invention pertains to the display of cosmetic materials within establishments that provide lodging and other services for travelers and other paying guests that is not coincident with the point of sale. Hotels, motels, motor inns, bed and breakfasts, country inns, apartments, condominiums, complexes, cottages, lodges, ranches, resorts, time-shares, suites, extended stays, histories, cruises, other lodging establishments, airplanes, trains, and other modes of transportation constantly seek new and innovative ways in which to please the customer. According to Lodging Magazine, innkeepers vie to provide hotel customers with special treats and items they did not know they needed. This can include local pop-out maps, massage oil, rubber duckies, and signature souvenirs such as blues music CODs and baseball caps. The Peninsula Beverly Hills even goes so far as to provide guests staying at one of the hotel's premiere suites or villas an Audi A8 for their use.

The purpose of this invention is to tap a growing market for personal care and cosmetic products by using placement in lodging facilities. According to Entrepreneur Magazine, The number of single women, for example, is growing the U.S. Census reports there were more than 48 million unmarried women in 1997, compared to 30 million in 1970. Today's unmarried women are often divorced or otherwise single by choice, professional, ambitious, affluent willing and able to spend on everything from personal services and cars to travel and real estate.” There are hotels and lodging establishments that even have certain rooms designated for women, such as the “Lady Crest” Hotel. According to Time Magazine, the “Lady Crest” rooms are more softly decorated than regular executive rooms, and come equipped with hair dryers, makeup mirrors, women's magazines, skirt hangers, irons and ironing boards, and an expanded range of toiletries.

The potential for advertising personal hygiene and cosmetic products does not only apply to women. Men's skin care products are becoming more and more prevalent. Kiehls, for instance, sells a Men's Alcohol-Free Herbal Toner. Aramis, a subsidiary of Estee Lauder, is developing a new line of male skin care under the name Surface. According to Lodging Magazine, “Hotels are looking for the most unique signature treatment they can find in order to differentiate themselves from the properties down the street” Sample, travel, trial size and full size cosmetics, fragrances and personal care products in cosmetic cases are the perfect amenity for women. A study by Conde Naste of over 5,000 women, covering the first quarter of 2000, shows samples influence more cosmetic sales than any other factor, including brand and price. This report further declares that a whopping 68% of women receiving cosmetic samples return to buy the full size product of the sample received. When the Hospitality Industry invests in these items, they will be investing in guests, and an exciting and newly discovered niche will be fulfilled. This niche will be fitting appropriate products to a growing market of business and leisure travelers, especially women.

The present invention fills a niche by connecting two, heretofore, unrelated industries. By lavishing women with products in which they have a phenomenally increasing and enthusiastic Interest, both the Hospitality and Cosmetic, Toiletry and Fragrance Industries will reap impressive numbers financially. Lodging facilities that can differentiate themselves by a higher quality of service without an increase in costs can realize increased revenue as a result of higher occupancy rates. Also, as studies show, sample distribution is the best form of advertising. By finding another outlet for sample distribution, the Cosmetic Industry can boost its reach to women who are extremely likely to purchase these products at stores in which they are sold.

The present invention provides a method for hotels, motels, motor inns, bed and breakfasts, country inns, apartments, condominiums, complexes, cottages, lodges, ranches, resorts, time-shares, suites, extended stays, histories, cruises, other lodging establishments, airplanes, trains, and other modes of transportation to differentiate themselves from the competition and promote their product (luxurious hotel rooms and services). The present invention also allows cosmetic companies to promote their products and provide a high level of service to lodging customers.

### SUMMARY OF THE INVENTION

The present invention generally relates to a method of advertising to potential customers. More particularly, the present invention pertains to the display of cosmetic materials within establishments that provide lodging and other services for travelers and other paying guests that is not coincident with the point of sale.

It should be understood that the term cosmetics covers not only makeup, but also perfumes, and many other products. Personal care is intended to cover a wider variety of products, including those geared towards men. It should also be understood that lodging establishment is intended to cover any facility that is not one's primary residence, and allows guests to stay for a period of time. This may be a hotel, motel, motor inn, bed and breakfast, country inn, apartment, condominium, complex, cottage, lodge, ranch, resort, timeshare, suite, extended stay, historic, cruise, other lodging establishments, airplane, train, and other modes of transportation.

In one aspect of the present invention, a method of advertising cosmetics on behalf of a cosmetic company in establishments that provide lodging is disclosed, comprising the steps of ascertaining at least one cosmetic company, ascertaining at least one cosmetic product produced by the cosmetic company, ascertaining target customer data associated with the cosmetic product according to a group of at least one item of quantitative data, ascertaining lodging customer, associating lodging customer data to the lodging customer according to a group of at least one item of quantitative data, selecting cosmetic products to provide in the lodging customers room according to the target customer data and the lodging customer data and prominently displaying the cosmetic products in the lodging customer's room. The cosmetic products may or may not be contained within a case. Also, the present invention envisions displaying the cosmetic products in public areas of lodging establishments, such as the bathroom of a health spa within the lodging establishment and common bathrooms.

According to another preferred embodiment, a method of advertising cosmetics on behalf of a cosmetic company in establishments that provide lodging is disclosed, comprising the steps of ascertaining at least one cosmetic company, wherein the cosmetic company has a package containing at least one cosmetic product, engaging in an agreement wherein lodging management of a lodging facility agrees to purchase the cosmetic products and the cosmetic company agrees to supply the cosmetic products, the lodging management providing the cosmetic products in its lodging facility.

According to another preferred embodiment, a method of advertising cosmetics on behalf of a cosmetic company is disclosed, comprising the steps of ascertaining lodging customer and associated lodging customer data according to a group of at least one item of quantitative data, ascertaining a multitude of cosmetic products and associated cosmetic product data according to at least one item of quantitative data, selecting the package of a multitude of cosmetic products to display in the lodging customer's room according to the target customer data and the lodging customer data and engaging in an agreement wherein lodging management of a lodging facility agrees to purchase the cosmetic products and the cosmetic company agrees to supply the cosmetic products, the lodging management prominently displaying and providing the cosmetic products in the lodging facility bathrooms.

### BRIEF DESCRIPTION OF THE DRAWINGS

FIG. 1 is a flow chart depicting a preferred embodiment according to the present invention; and

FIG. 2 is a flow chart depicting a preferred embodiment according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

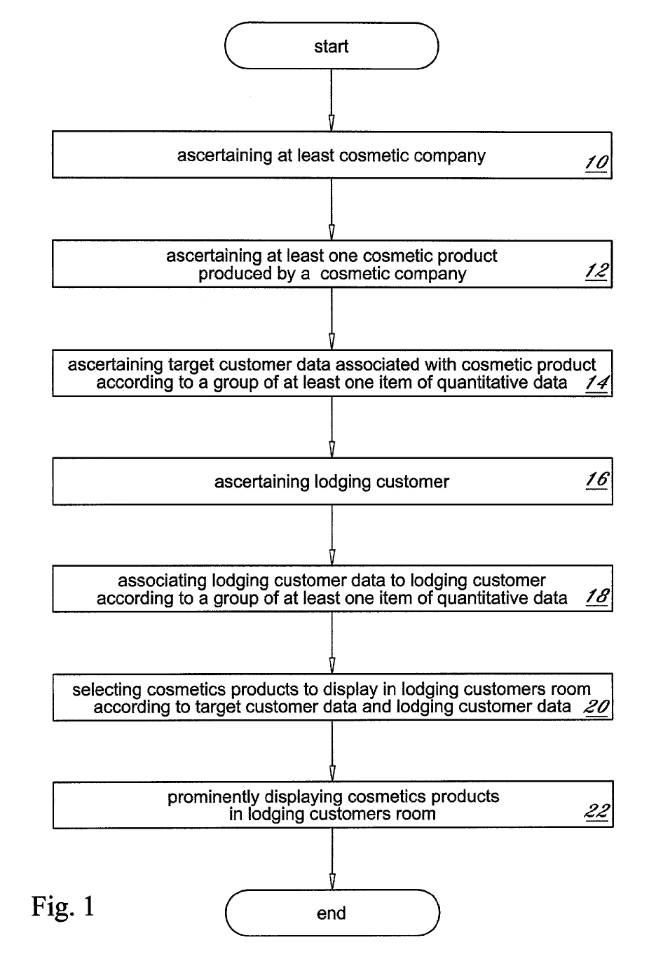

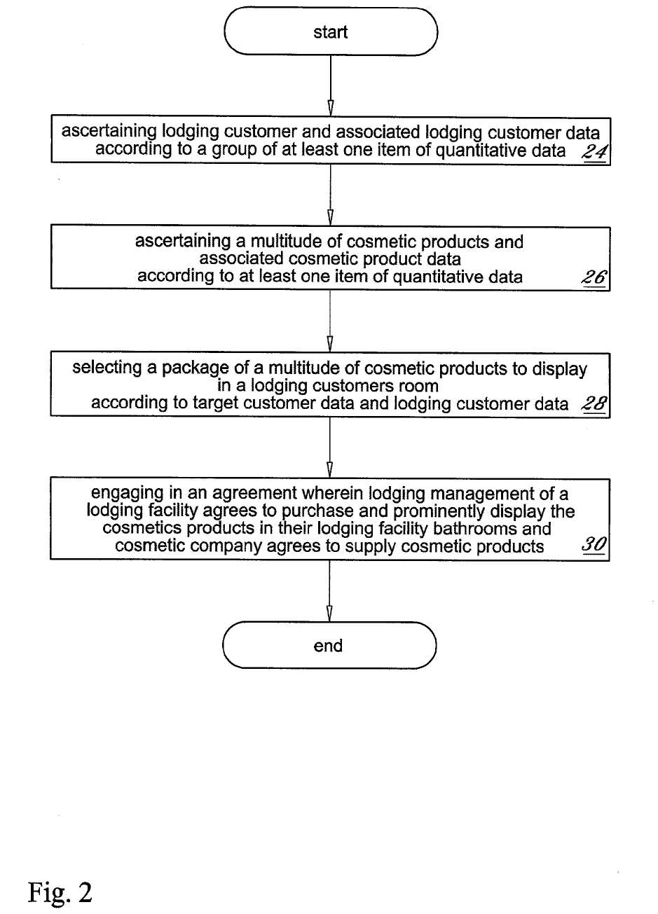

According to a preferred embodiment of the present invention as shown in FIGS. 1-2, a method of advertising cosmetics on behalf of a cosmetic company in establishments that provide lodging is disclosed. This method is comprised of the steps of ascertaining at least one cosmetic company (10). By way of example, this may be a subsidiary of Estee Lauder, a parent company such as Unilever, or any company or person attempting in the business of selling cosmetics. Next, at least one cosmetic product produced by this cosmetic company (12) is ascertained. This cosmetic product may be selected from the group consisting of mascara, two-in-one mascara and lash separator, eyeliner, eyelash curler, eyebrow pencil, fake eyelashes, eyebrow comb, eyelash comb, tweezers, eyeshadow, eye pencil sharpener, lipstick, lip pencil, lip pencil sharpener, lipcolor pack containing both color and menthol-infused medicated balm, lip gloss, lip protectant, Chapstick™, products that keep lipstick from being removed, cover-up for under eyes and blemishes, face powder, foundation, blush, three-in-one makeup sticks combining foundation, concealer and powder blush, makeup remover, body art/glitter/tattoos, sunscreen, self tanning cream, petroleum jelly, baby oil, ceramide capsules, brushes, applicators, compact mirror, powder puff, cotton swabs, cotton balls, nail polish, nail polish remover, nail file, nail brush, fake nails, nail glue, nail/cuticle oil, nail decals, pumice stone, odor-free polish-removing wipes, fragrance, cologne, toilette water, perfume and any other scented liquid and/or solid, shaving cream, aftershave fragrance and lotion, specialty skincare lotions, and hair products for coloring, shining, de-frizzing, straightening, curling, thickening and thinning hair. It should also be understood that these products may be any size, including trial size, sample, full and new. Also, the products may be contained within a case. A case is meant to include any cosmetic case. This may be plastic, fabric or any personal effects container known within the art.

For each cosmetic product, target customer data is to be associated with this cosmetic product according to a group of at least one item of quantitative data (14). This quantitative data may be age, income, geographic residence, employment industry, race, and/or sex. For instance, a particular perfume may have target customer data consisting of 40-45 year olds, making over $50,000/year and female.

Next a lodging customer is ascertained (16), and lodging customer data may be associated to said customer according to a group of at least one item of quantitative data (18). The quantitative data may be any of the same categories as previously mentioned including age, income, geographic residence, employment industry, race, and/or sex. It may be the same exact data as the target customer data. However, it may also be separate sets of data, with some overlap. For instance, the target customer data may be aged 20-25 with an income over $25,000 and male. The lodging customer may only fit one of these criteria. It is not necessary that each item of quantitative data associated with the target customer data and lodging customer data is identical. It may be as simple as one item of data, such as sex or the quality of a room. For instance, each business room is standardly equipped with an amenities bag consisting of a variety of cosmetics. It should be understood that lodging customer criteria may be obtained in any number of ways. This may include a series of questions upon booking the mom, check-in clerk determination, or response to a survey. Cosmetic products are selected for prominent display in a lodging customer's room according to target customer data (20) and lodging customer data (22). The cosmetic products may be trial sizes offered at a place that is not coincident with the point of sale with information on how to obtain refills or standard size items. The term not coincident with the point of sale means that it is not in a retail environment, is offered for free, is offered with the option of paying at a later time (e.g. applied to a room bill) or even is offered for free if the customer watches a related advertisement. For example, a blue eyeshadow specifically selected for the lodging customer may be provided and not billed to their room if they watch a targeted in room advertisement (for example a television add on the in room television). If they do not watch the advertisement, a bill for the cosmetic product may appear on their room bill. If they do watch the targeted advertisement the cosmetic product will be offered for free. This creates the feeling of a non sales environment and maximizes the advertising impact. In the alternative items may be selected according to the guest and offered for sale. For example, it may be determined that the guest has blue eyes and blue eyeshadow would complement their coloring. Accordingly, blue eye shadow may be offered for sale. This is not a retail environment, though, rather targeted marketing of select items. Further, the cosmetic product (e.g. blue eye shadow) is being offered at a place that is not coincident with the point of sale. That is to say that the cosmetic product is not paid for in the hotel room. It is envisioned that the cosmetic product may appear on the hotel bill, but not coincident with the selection of the cosmetic product in the room (i.e. not coincident with the point of sale). Specifically selected and tailored cosmetics products that may be offered for free or applied to a hotel bill at a later time benefit the hotel guest by providing the feeling of personalization and provide advertising for the cosmetic company that is specifically directed to highly targeted potential customers.

According to another embodiment, a method of advertising cosmetics on behalf of a cosmetic company in establishments that provide lodging is disclosed. This method comprises the steps of ascertaining at least one cosmetic company, wherein this cosmetic company has a package containing at least one cosmetic product, engaging in an agreement wherein lodging management of a lodging facility agrees to purchase said cosmetic products and said cosmetic company agrees to supply said cosmetic products, and the lodging management providing the cosmetic products in its lodging facility. Cosmetic products, as discussed previously, may be any number of products and sizes. Also, the cosmetic products may be placed in a number of places in the lodging facility, such as a lodging customer's room, common bathroom areas and spa areas. It is important that the cosmetic products, though, are specifically selected according to the individual and are displayed, but not in a retail environment, this gives the customer a feeling that items specifically selected for them have been provided and provides advertising for the cosmetic products. The cosmetic company may provide advertising literature related to the cosmetics products provided in the lodging customer's room prior according to the target customer data and the lodging customer data. The advertising literature may direct the customer to the location of a retail environment in which they can obtain the specifically selected cosmetic product. This may be, for example, a website or even the closest location to the customers home address. In this way, the customer may feel even more catered to benefiting the lodging establishment, the cosmetics company and the lodging customer.

According to another embodiment, as shown in FIG. 2, a method of advertising cosmetics on behalf of a cosmetic company is disclosed, comprising the steps of ascertaining lodging customer and associated lodging customer data according to a group of at least one item of quantitative data (24), ascertaining a multitude of cosmetic products and associated cosmetic product data according to at least one item of quantitative data (26), selecting a package of a multitude of cosmetic products to display in a lodging customer's room according to target customer data and lodging customer data (28), engaging in an agreement wherein lodging management of a lodging facility agrees to purchase and provide the cosmetic products in their lodging facility bathrooms and cosmetic company agrees to supply cosmetic products (30). It should be understood that products may be provided in the lodging customer's room, but they may also be provided in the locker room of the lodging facility's gym.

It should be understood, of course, that the foregoing relates to preferred embodiments of the invention and that modifications may be made without departing from the spirit and scope of the invention as set forth in the following claims.

I claim:

1. A non-retail environment method of advertising cosmetics on behalf of a cosmetic company in the room of a target customer in establishments that provide lodging, comprising the steps of; ascertaining at least one cosmetic company;
ascertaining at least one cosmetic product produced by said cosmetic company;
ascertaining target customer data associated with said cosmetic product according to a group of at least one item of quantitative data;
ascertaining lodging customer;
associating lodging customer data to said lodging customer prior to said lodging customer reaching the lodging establishment according to a group of at least one item of quantitative data;
selecting cosmetic products to provide in said lodging customers room prior to said lodging customer reaching the lodging establishment according to said target customer data and said lodging customer data; and
prominently displaying said cosmetic products in said lodging customer's room.

2. A method as in claim 1, wherein said item of quantitative data is selected from the group consisting of age, income, geographic residence, employment industry, race, sex.

3. A method as in claim 1, wherein at least one item of quantitative data is provided directly by said lodging customer in response to a survey.

4. A method as in claim 1, wherein said cosmetic product is selected from the group consisting of trial size, sample, new and full-size.

5. A method as in claim 1, wherein said cosmetic product is selected from the group consisting of mascara, two-in-one mascara and lash separator, eyeliner, eyebrow pencil, eye pencil sharpener, eyeshadow, fake eyelashes, eyebrow comb, eyelash comb, eyelash curler, eyepencil sharpener, lipstick, lip pencil, lip pencil sharpener, lipcolor pack containing both color and menthol-infused medicated balm, lip gloss, lip protectant, Chapstick™, products that keep lipstick from being removed, cover-up for under eyes and blemishes, face powder, foundation, blush, three-in-one makeup sticks combining foundation, concealer and powder blush, makeup remover, body art/glitter/tattoos, sunscreen, self tanning cream, petroleum jelly, baby oil, ceramide capsules, tweezers, brushes, applicators, compact mirror, powder puff, cotton swabs, cotton balls, nail polish, nail polish remover, nail file, nail brush, fake nails, nail glue, nail/cuticle oil, nail decals, pumice stone, odor-free polish-removing wipes, fragrance, cologne, toilette water, perfume and any other scented liquid and/or solid, shaving cream, aftershave fragrance and lotion, specialty skincare lotions, and hair products for coloring, shining, de-frizzing, straightening, curling, thickening and thinning hair.

6. A method as in claim 1, wherein said cosmetic product is contained in a case.

7. A method as in claim 1, further comprising the step:
providing advertising literature related to said cosmetics products provided in said lodging customer's room prior according to said target customer data and said lodging customer data.

8. A method as in claim 1, further comprising the step of:
offering said cosmetics products provided in said lodging customer's room prior free of charge upon said customer watching a targeted in room advertisement.

9. A non-retail environment method of advertising cosmetics on behalf of a cosmetic company in the room of a target customer in establishments that provide lodging, comprising the steps of;
ascertaining lodging customer and associated lodging customer data according to a group of at least one item of quantitative data prior to said lodging customer reaching the lodging establishment;
ascertaining a multitude of cosmetic products and associated cosmetic product data according to at least one item of quantitative data;
selecting a package of a multitude of cosmetic products to display in said lodging customer's room according to said target customer data and said lodging customer data prior to said lodging customer reaching the lodging establishment; and
engaging in an agreement wherein lodging management of a lodging facility agrees to purchase said cosmetic products and said cosmetic company agrees to supply said cosmetic products, said lodging management prominently displaying and providing said cosmetic products in said lodging facility.

10. A method as in claim 9, wherein said item of quantitative data is selected from the group consisting of age, income, geographic residence, employment industry, race, sex.

11. A method as in claim 9, wherein at least one item of quantitative data is provided directly by said lodging customer in response to a survey.

12. A method as in claim 9, wherein said cosmetic product is selected from the group consisting of trial size, sample, new and full size.

13. A method as in claim 9, wherein said cosmetic product is selected from the group consisting of mascara, two-in-one mascara and lash separator, eyeliner, eyebrow pencil, eyeshadow, fake eyelashes, eyebrow comb, eyelash comb, brushes, applicators, eyelash curler, eyepencil sharpener, lipstick, lip pencil, lip pencil sharpener, lipcolor pack containing both color and menthol-infused medicated balm, lip gloss, lip protectant, Chapstick™, products that keep lipstick from being removed, cover-up for under eyes and blemishes, face powder foundation, blush, three-in-one makeup sticks combining foundation, concealer and powder blush, makeup remover, body art/glitter/tattoos, sunscreen, self tanning cream, ceramide capsules, compact mirror, powder puff, nail polish, nail polish remover, nail file, fake nails, nail glue, nail/cuticle oil, nail decals, pumice stone, odor-free polish-removing wipes, fragrance, cologne, toilette water, perfume and any other scented liquid and/or solid, shaving cream, aftershave fragrance and lotion, specialty skincare lotions, and hair products for coloring, shining, de-frizzing, straightening, curling, thickening and thinning hair.

14. A method as in claim 9, wherein said package of a multitude of cosmetic products is contained within a case.

15. A method as in claim 9, further comprising the step:
providing advertising literature related to said cosmetics products provided in said lodging customer's room prior according to said target customer data and said lodging customer data.

16. A method as in claim 9, further comprising the step of:
offering said cosmetics products provided in said lodging customer's room prior free of charge upon said customer watching a targeted in room advertisement.
